(19) United States
(12) Patent Application Publication
(10) Pub. No.: US 2002/0042343 A1
(43) Pub. Date: Apr. 11, 2002

(54) Coating composition for forming titanium oxide film, process for forming titanium oxide film and photocatalyst

(75) Inventors: Jun Akui, Hiratsuka-shi (JP); Hideo Kogure, Atsugi-shi (JP); Osamu Isozaki, Yokohama-shi (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: KANSAI PAINT CO., LTD., Amagasaki-shi (JP)

(21) Appl. No.: 09/854,473

(22) Filed: May 15, 2001

(30) Foreign Application Priority Data
May 16, 2000 (JP) 2000-143224
May 16, 2000 (JP) 2000-143225

(51) Int. Cl. B01J 23/00

(52) U.S. Cl. 502/350; 502/349

(57) ABSTRACT

The present invention provides a coating composition for forming a titanium oxide, comprising (A) an aqueous peroxo titanic acid solution obtained by mixing, with aqueous hydrogen peroxide, a titanium compound containing a group or groups convertible to a hydroxyl group by hydrolysis and/or a low condensate of the compound and (B) polyethylene glycol; a process for forming a titanium oxide film, comprising applying the coating composition to a substrate and calcining the resulting coating at a temperature not lower than 200° C. to form a porous titanium oxide film; and a photocatalyst comprising a porous titanium oxide film formed on a substrate by the process.

The present invention relates to a coating composition and process for forming a titanium oxide film having excellent photocatalytic activities, and a photocatalyst.

Known processes for forming a titanium oxide film include: (1) a process comprising applying a titanium oxide sol to a substrate and calcining the sol, (2) a process comprising applying an aqueous solution of titanium chloride or titanium sulfate to a substrate and calcining the resulting coating, (3) sputtering in a vacuum using titanium oxide as the target to deposit a film on a substrate, and (4) a CVD process comprising volatilizing and decomposing an organic titanium compound in an electric furnace to deposit a film on a substrate.

However, process (1) has the drawback of inferior film-forming properties, and thus a 0.1 μm thick or thicker film formed by this process develops cracks and peeling. In process (2), a heat decomposed product of the aqueous solution exhibits adverse effects on the substrate. Processes (3) and (4) require reduced pressure to produce a film with good properties, thus necessitating an evacuatable reactor. Further, processes (3) and (4) have the drawback of slow film formation rate. Moreover, none of the processes (1) to (4) is capable of forming a porous titanium oxide film.

Recently, there have been proposed (5) a process comprising applying, to a substrate, an aqueous hydrogen peroxide solution of titanium hydroxide obtained from a basic substance and an aqueous solution of titanium chloride or titanium sulfate, and heating or calcining the resulting coating to form a titanium oxide film (Japanese Unexamined Patent Publication No. 1997-71418), (6) a process comprising dipping a substrate in an aqueous hydrogen peroxide solution of titanium oxide obtained by mixing and heating tetraisopropoxytitanium, isopropanol and water, and calcining the resulting coating to form a titanium oxide film (Japanese Unexamined Patent Publication No. 1998-46317) and like processes.

However, process (5) includes a complicated step of preparing the aqueous hydrogen peroxide solution of titanium hydroxide, and involves troublesome procedures to remove the basic substance. Further, it is difficult to obtain a high purity titanium oxide film by process (5) since the film is liable to be contaminated with metals such as Fe and Cu contained in the starting material. Process (6) is expensive because it necessitates a large amount of isopropanol to prepare the aqueous hydrogen peroxide solution of titanium oxide. Furthermore, neither of processes (5) and (6) is capable of forming a porous titanium oxide film.

An object of the present invention is to provide a coating composition for forming a titanium oxide film and a process for forming a titanium oxide film which are free from the drawbacks of the prior art and capable of forming a porous titanium oxide film with ease, and a photocatalyst.

Other objects and features of the present invention will become apparent from the following description.

The present invention provides the following coating compositions for forming a titanium oxide film, processes for forming a titanium oxide film, and photocatalysts.

1. A coating composition for forming a titanium oxide film, comprising (A) an aqueous peroxo titanic acid solution obtained by mixing, with aqueous hydrogen peroxide, a titanium compound containing a group or groups convertible into a hydroxyl group by hydrolysis and/or a low condensate of the compound and (B) polyethylene glycol.

2. A coating composition according to item 1, wherein the titanium compound is a tetraalkoxytitanium represented by the formula

Ti(OR)₄ (I)

wherein Rs may be the same or different and each represent C₁ to C₅ alkyl.

3. A coating composition according to item 1, wherein the low condensate of a titanium compound is a compound having a condensation degree of 2 to 30 and obtained by self-condensing a tetraalkoxytitanium represented by the formula

Ti(OR)₄ (I)

wherein Rs may be the same or different and each represent C₁ to C₅ alkyl.

4. A coating composition according to item 1, wherein the proportion of the aqueous hydrogen peroxide is 0.1 to 100 parts by weight calculated as hydrogen peroxide, per 10 parts by weight of the titanium compound containing a group or groups convertible into a hydroxyl group by hydrolysis and/or a low condensate of the compound.

5. A coating composition according to item 1, wherein the aqueous peroxo titanic acid solution (A) is a solution obtained by mixing a titanium compound containing a group or groups convertible into a hydroxyl group by hydrolysis and/or a low condensate of the compound, with aqueous hydrogen peroxide in the presence of a titanium oxide sol.

6. A coating composition according to item 5, wherein the titanium oxide sol is an aqueous dispersion of anatase titanium oxide.

7. A coating composition according to item 5, wherein the proportion of the titanium oxide sol is 0.01 to 10 parts by weight as solids, per 1 part by weight of the titanium compound containing a group or groups convertible into a hydroxyl group by hydrolysis and/or a low condensate of the compound.

8. A coating composition according to item 1, wherein the aqueous peroxo titanic acid solution (A) is a dispersion of titanium oxide particles having an average particle size not greater than 10 nm, the dispersion being obtainable by: mixing, with aqueous hydrogen peroxide, a titanium compound containing a group or groups convertible to a hydroxyl group by hydrolysis and/or a low condensate of the compound; and subjecting the resulting aqueous peroxo titanic acid solution to heat treatment or autoclave treatment at a temperature not lower than 80° C.

9. A coating composition according to item 1, wherein the polyethylene glycol (B) has an average molecular weight of 200 to 4,000,000.

10. A coating composition according to item 1, wherein the proportion of the polyethylene glycol (B) is 0.1 to 200 parts by weight, per 100 parts by weight of the solids in the aqueous peroxo titanic acid solution (A).

11. A process for forming a titanium oxide film, comprising the steps of applying a coating composition according to item 1 to a substrate, and calcining the resulting coating at a temperature not lower than 200° C. to form a porous titanium oxide film.

12. A process for forming a titanium oxide film according to item 11, wherein the porous titanium oxide film is a porous film of anatase titanium oxide.

13. A photocatalyst comprising a porous titanium oxide film formed on a substrate by a process according to item 11.

14. A photocatalyst according to item 13, wherein the porous titanium oxide film is a porous film of anatase titanium oxide.

The present inventors conducted extensive research to achieve the above object. As a result, they found that a coating composition, which comprises (A) an aqueous peroxo titanic acid solution obtained by mixing, with aqueous hydrogen peroxide, a titanium compound containing a group or groups convertible to a hydroxyl group by hydrolysis and/or a low condensate of the compound and (B) polyethylene glycol, has the following advantages: the coating composition is excellent storage stability and free of problems in production; a titanium oxide film can be easily formed by applying the coating composition to a substrate and calcining the resulting coating; the titanium oxide film is a dense, porous film with good adhesion; and the film is improved in photocatalytic activities of titanium oxide because of its porosity.

The present invention has been accomplished based on the above novel findings.

The aqueous peroxo titanic acid solution (A) for use in the coating composition for forming a titanium oxide film of the present invention is obtained by mixing, with aqueous hydrogen peroxide, a titanium compound containing a group or groups convertible to a hydroxyl group by hydrolysis and/or a low condensate of the compound.

The titanium compound is preferably a tetraalkoxytitanium represented by the formula

Ti(OR)₄ (I)

wherein Rs may be the same or different, and each represent C₁ to C₅ alkyl. Examples of C₁ to C₅ alkyl represented by R include methyl, ethyl, n-propyl, isopropyl, n-butyl, isobutyl, sec-butyl and tert-butyl.

The low condensate of the titanium compound is preferably a compound having a condensation degree of 2 to 30, in particular 2 to 10, and obtained by self-condensing a compound represented by the formula (I).

The proportion of the aqueous hydrogen peroxide is 0.1 to 100 parts by weight, in particular 1 to 20 parts by weight, calculated as hydrogen peroxide, per 10 parts by weight of the titanium compound containing a group or groups convertible to a hydroxyl group by hydrolysis and/or a low condensate of the compound (hereinafter the titanium compound and/or its low condensate is simply referred to as “hydrolyzable titanium compound”). Less than 0.1 part by weight of aqueous hydrogen peroxide (calculated as hydrogen peroxide) will result in insufficient formation of peroxo titanic acid, producing opaque precipitates. On the other hand, if more than 100 parts by weight (calculated as hydrogen peroxide) of aqueous hydrogen peroxide is used, it is likely that part of hydrogen peroxide remains unreacted and emits hazardous active oxygen during storage.

The hydrogen peroxide concentration in the aqueous hydrogen peroxide is not limited, but is preferably 3 to 40 wt. %, considering ease of handling.

The aqueous peroxo titanic acid solution (A) for use in the composition of the invention can be prepared usually by mixing a hydrolyzable titanium compound with aqueous hydrogen peroxide with stirring at about 1 to 70° C. for about 10 minutes to 20 hours. If necessary, methanol, ethanol, n-propanol, isopropanol, ethylene glycol monobutyl ether, propylene glycol monomethyl ether or like water-soluble solvent may be also mixed together.

Presumably, the aqueous peroxo titanic acid solution (A) is obtained through the following mechanism: When the hydrolyzable titanium compound is mixed with aqueous hydrogen peroxide, the compound is hydrolyzed with water and converted into a hydroxyl-containing titanium compound. Immediately thereafter, hydrogen peroxide is coordinated to the hydroxyl-containing titanium compound to thereby form peroxo titanic acid. The aqueous peroxo titanic acid solution (A) is highly stable at room temperature and durable for long-term storage.

When the aqueous peroxo titanic acid solution (A) is prepared by mixing a hydrolyzable titanium compound with aqueous hydrogen peroxide in the presence of a titanium oxide sol, the composition of the invention comprising the solution (A) and polyethylene glycol (B) is improved in storage stability and capable of forming a titanium oxide film improved in photocatalytic activities. The reason for the improvements is presumed as follows: During preparation of the aqueous solution (A) the hydrolyzable titanium compound is adsorbed on the titanium oxide sol particles and chemically bonded to hydroxyl groups generated on the particle surface by condensation. Further, the hydrolyzable titanium compound undergoes self-condensation and is converted into a high molecular compound, which is then mixed with aqueous hydrogen peroxide. As a result, a coating composition comprising the resulting aqueous solution (A) is further stabilized and remarkably free of gelation and thickening during storage.

If a titanium oxide sol is used singly in place of the aqueous solution (A), the sol exhibits poor film-forming properties. Further, even if an aqueous peroxo titanic acid solution is added to the sol, the sol shows poor compatibility with the aqueous peroxo titanic acid solution and is not remarkably improved in film-forming properties.

The titanium oxide sol for use in the invention comprises amorphous titanium oxide particles or anatase titanium oxide particles dispersed in water. As the titanium oxide sol, an aqueous dispersion of anatase titanium oxide is preferred from the viewpoint of photocatalytic activities. The titanium oxide sol may contain, in addition to water, an aqueous organic solvent such as an alcohol solvent or an alcohol ether solvent.

The titanium oxide sol may be known one, such as a dispersion of amorphous titanium oxide particles obtained by dispersing titanium oxide agglomerates in water, or a dispersion in water of anatase titanium oxide particles obtained by calcining titanium oxide agglomerates. Amorphous titanium oxide can be converted into anatase titanium oxide by calcination at a temperature not lower than the anatase crystallization temperature, usually at a temperature not lower than 200° C. Examples of titanium oxide agglomerates include (1) agglomerates obtained by hydrolysis of an inorganic titanium compound such as titanium sulfate or titanyl sulfate, (2) agglomerates obtained by hydrolysis of an organic titanium compound such as titanium alkoxide, (3) agglomerates obtained by hydrolysis or neutralization of a solution of titanium halide such as titanium tetrachloride.

Commercially available titanium oxide sols include, for example, “TKS-201” (a tradename of TEICA Corp., an aqueous sol of anatase titanium oxide particles having an average particle size 6 nm), “TA-15” (a tradename of Nissan Chemical Industries, Ltd., an aqueous sol of anatase titanium oxide particles) and “STS-11” (a tradename of Ishihara Sangyo Kaisha, Ltd., an aqueous sol of anatase titanium oxide particles).

The amount of the titanium oxide sol used when mixing the hydrolyzable titanium compound and aqueous hydrogen peroxide is, as solids, usually 0.01 to 10 parts by weight, preferably 0.1 to 8 parts by weight, per 1 part by weight of the hydrolyzable titanium compound. Less than 0.01 part by weight of the titanium oxide sol fails to achieve the effect of adding a titanium oxide sol, i.e., improvement of storage stability of the coating composition and photocatalytic activities of the titanium oxide film. On the other hand, more than 10 parts by weight of the sol impairs the film-forming properties of the coating composition.

The aqueous peroxo titanic acid solution (A) may be used in the form of a dispersion of titanium oxide particles with an average particle size not greater than 10 nm. Such a dispersion can be prepared by mixing the hydrolyzable titanium compound with aqueous hydrogen peroxide, and then subjecting the resulting aqueous peroxo titanic acid solution to heat treatment or autoclave treatment at a temperature not lower than 80° C. The dispersion usually has a translucent appearance.

If the heat treatment or autoclave treatment is carried out at a temperature lower than 80° C., the crystallization of titanium oxide does not proceed sufficiently. The titanium oxide particles obtained by heat treatment or autoclave treatment have a particle size not greater than 10 nm, preferably a particle size of 1 nm to 6 nm. If the titanium oxide particles have a particle size greater than 10 nm, the resulting coating composition has such poor film-forming properties that a film with a thickness of 1 μm or greater will develop cracks.

The polyethylene glycol (B) for use in the coating composition of the invention volatilizes when calcining the coating composition applied on a substrate, and produces numerous pores upon volatilization, rendering the titanium oxide film porous. The polyethylene glycol (B) is in a liquid or solid state at 20° C., and preferably has an average molecular weight of 200 to 4,000,000, in particular 600 to 70,000. The polyethylene glycol (B) may be, for example, a commercial product having an average molecular weight of 600, 1,000, 1,500, 2,000, 3,000, 8,500, 20,000, 70,000, 500,000 or 4,000,000.

The proportion of the polyethylene glycol (B) in the coating composition of the invention is 0.1 to 200 parts by weight, preferably 1 to 100 parts by weight, per 100 parts by weight of the solids in the aqueous peroxo titanic acid solution (A). The solids in the aqueous peroxo titanic acid solution (A) means the solids calculated as titanium dioxide. Less than 0.1 part by weight of the polyethylene glycol (B) fails to make the titanium oxide film sufficiently porous. On the other hand, more than 200 parts by weight of the polyethylene glycol (B) results in variation of pore size, failing to obtain a uniform porous film.

The coating composition of the invention may optionally contain additives, such as a commercially available titanium oxide sol, titanium oxide powder and pigment.

The coating composition of the invention can be suitably formed into a porous titanium oxide film, by applying the composition to a substrate and calcining the resulting coating at a temperature not lower than 200° C. The coating composition of the invention contains only a small amount of impurities (substances other than titanium oxide) so that the resulting titanium oxide film has a high titanium oxide purity.

The coating composition can be applied to a substrate by any known processes, such as print coating, knife coating, doctor blade coating, dip coating, shower coating, spray coating, roll coating and electrocoating.

The substrate for the coating composition of the invention may be made of any material that withstands calcination or heat treatment, such as metal, ceramic, plastic, fiber, glass or concrete. Further, the substrate may have any shape, such as planar, spherical, rectangular or cylindrical. It is also possible to use a porous article or a powder as the substrate, and treat the inside of the porous material or the powder surface with the coating composition. Examples of porous articles include honeycomb structures and corrugated structures. Examples of powders include mica, talc, silica, barium sulfate, clay and like extender pigments.

The coating composition of the invention is applied to a substrate and calcined at a temperature not lower than 200° C. to obtain a dense, uniform porous titanium oxide film with good adhesion. The obtained porous film is made of anatase titanium oxide owing to the calcination at a temperature not lower than 200° C., and thus has remarkably improved photocatalytic activities. If the calcination temperature exceeds 915° C., anatase titanium oxide undergoes transition into rutile titanium oxide. Thus, the upper limit of the calcination temperature is 915° C. Preferably, the calcination temperature is about 200 to 700° C. The calcination time is usually about 10 minutes to 3 hours, although depending upon the calcination temperature.

The degree of porosity of the resulting porous titanium oxide film, when expressed in terms of specific surface area, is usually about 10 to 800 m²/g, in particular about 50 to 500 m²/g.

The porous titanium oxide film is preferably about 0.001 to 20 μm thick, in particular 0.1 to 15 μm thick. Usually, a single coat of the coating composition gives a thick (1 μm or thicker), uniform, dense, porous titanium oxide film that has good adhesion and is difficult to peel off. Of course, several coats may be applied as required.

When the aqueous peroxo titanic acid solution (A) is obtained by mixing a hydrolyzable titanium compound with aqueous hydrogen peroxide in the presence of a titanium oxide sol, the resulting coating composition can be more easily formed into a thick film.

If the coating composition of the invention is applied to a substrate and then dried by heating at a temperature lower than 200° C., an amorphous titanium oxide film is formed. This film is not desirable because it has lower adhesion and is non-porous.

When the aqueous peroxo titanic acid solution (A) is used in the form of a dispersion of titanium oxide particles having an average particle size not greater than 10 nm, which dispersion is obtained by heat treatment or autoclave treatment (at a temperature not lower than 80° C.) of an aqueous peroxo titanic acid solution prepared by mixing a hydrolyzable titanium compound with aqueous hydrogen peroxide, the resulting coating composition can be formed into a uniform, dense, porous anatase titanium oxide film with good adhesion, by calcination at a temperature not lower than 200° C.

If a coating composition comprising the dispersion of titanium oxide particles as the solution (A) is applied and dried by heating at a temperature lower than 200° C., an anatase titanium oxide film is formed. This film is not desirable because it has lower adhesion and is non-porous. However, this film is usable for a material that does not withstand heat treatment.

In this case, the obtained titanium oxide film is capable of being impregnated as well as having water resistance. Thus, the film can be impregnated with a solution of a substance other than titanium oxide and calcined or heat-dried to form a composite comprising the other substance supported or dispersed within the titanium oxide film. The other substance is not limited, and may be, for example, a metal selected from gold, silver, copper and platinum group elements (ruthenium, rhodium, palladium, osmium, iridium and platinum) or a metal compound such as an oxide, a chloride or a complex of these metals.

The titanium oxide film obtained by the invention is a uniform porous film with good adhesion, and is usually made of anatase titanium oxide. Accordingly, the photocatalytic activities of the titanium oxide in the titanium oxide film are remarkably improved. Therefore, a photocatalyst comprising a porous titanium oxide film formed on a substrate according to the invention has excellent photocatalytic activities such as antibacterial properties, hydrophilicity, stain resistance, fog resistance, gas decomposing properties, deodorizing properties, water-treating properties, energy converting properties and bleaching properties.

The photocatalyst of the invention can be suitably used in the fields of, for example, atmosphere purification, water purification, hydrophilization, antibacterial treatment, deodorization, fog proofing, waste water treatment and energy conversion.

More specifically, the photocatalyst is useful, for example, to transform nitrogen oxide or the like into nitric acid by oxidation or to decompose acetaldehyde.

When the photocatalyst of the invention is utilized as an energy-converting material, a sensitizing dye is preferably applied onto the surface of the titanium oxide film. The sensitizing dye has an absorption in the visible region and/or the infrared region, and may be at least one member selected from metal complexes and organic dyes. Preferred as the sensitizing dye is one having, in a molecule, a functional group or groups such as carboxyl, hydroxyalkyl, hydroxyl, sulfone or carboxyalkyl, since such a sensitizing dye is rapidly adsorbed onto semiconductors. Further, a metal complex is preferred because of its excellent spectral sensitization effect and durability.

Examples of metal complexes include copper phthalocyanine, titanyl phthalocyanine and like metal phthalocyanines; chlorophyll; hemin; complexes of ruthenium, osmium, iron and zinc, as described in Japanese Unexamined Patent Publications No. 1989-220380 and No. 1993-504023. Examples of organic dyes include metal-free phthalocyanines, cyanine red dyes, merocyanine dyes, xanthene dyes and triphenylmethane dyes. Specific examples of cyanine dyes include “NK1194” and “NK3422” (tradenames of Nihon Kanko Shikiso Kenkyusho). Specific examples of merocyanine dyes include “NK2426” and “NK2501” (tradenames of Nihon Kanko Shikiso Kenkyusho). Specific examples of xanthene dyes include uranine, eosin, Rose-Bengal, Rhodamine B and dibromofluorescein. Specific examples of triphenylmethane dyes include malachite green and crystal violet.

The titanium oxide film obtained by the invention is excellent in, as well as photocatalytic activities, heat resistance, corrosion resistance and like properties. Accordingly, the film is useful as a heat-resistant film, a corrosion-resistant film or the like.

The following Examples, Comparative Examples and Test Examples are provided to illustrate the present invention in further detail, and are not intended to limit the scope of the claims herein. In the following examples, parts and percentages are all by weight.

In Test Examples, the storage stability, film condition, adhesion, pencil hardness, water resistance, wettability (water contact angle) and specific surface area were tested by the following methods.

(1) Storage stability of the coating compositions: The coating compositions were stored at 50° C. for 100 hours, and thereafter checked for change in viscosity and presence of precipitates to evaluate the storage stability.

(2) Film condition: The titanium oxide films were checked for smoothness, transparency and abnormalities such as cracks, with the naked eye. Films without abnormalities were rated good.

(3) Adhesion: According to JIS K5400 8.5.2 (1990), a cross cut tape test was carried out. Specifically, 100 squares (1 mm×1 mm) were formed on the surface of each titanium oxide film, and an adhesive tape was adhered to the surface and the peeled off. Thereafter, the number of remaining squares was counted to evaluate the adhesion.

(4) Pencil hardness: According to JIS K5400 8.4.2 (1990), a pencil scratch test was carried out, and the titanium oxide films were checked for scratches to evaluate the pencil hardness.

(5) Water resistance: The titanium oxide films were soaked in water at 20° C. for 7 days, and then checked for abnormalities such as blushing, blistering and peeling, with the naked eye. Films without abnormalities were rated good.

(6) Wettability: Each of the titanium oxide films was irradiated for 5 minutes with a 4 KW high pressure mercury lamp placed 30 cm away from the film surface. Then, the water contact angle was measured to evaluate the wettability. The measurement of the water contact angle was carried out by forming a 0.03 cc drop of deionized water on a test coated plate at 20° C., and then measuring the contact angle of the drop with a contact angle meter DCCA manufactured by Kyowa Chemical Industry Co., Ltd.

(7) Specific surface area: Each of the coating compositions was applied to a glass plate to a thickness of 1.0 μm (when calcined) using a bar coater, and calcined at 500° C. for 30 minutes to form a titanium oxide film. Subsequently, a 0.5 cm wide and 2 cm long piece was cut out from the titanium oxide film, peeled off from the glass plate to obtain a test sample. The test sample was placed in a measurement cell, and the surface area (m²) of the test sample was measured using “Micromeritics accelerated surface area and porosimetry 2010” (Shimadzu Corp., ASAP 2010 krypton type) by the constant volume method (gas adsorption method) defined in ISO 9277. Then, the specific surface area per sample weight (m²/g) was calculated. The specific surface area indicates the porosity of the titanium oxide film.

Examples of Coating Compositions Comprising an Aqueous Peroxo Titanic Acid Solution (A) Obtained by Mixing a Hydrolyzable Titanium Compound With Aqueous Hydrogen Peroxide and Polyethylene Glycol (B)

### EXAMPLE 1

A mixture of 10 parts of tetraisopropoxytitanium and 10 parts of isopropanol was added dropwise to a mixture of 10 parts of 30% aqueous hydrogen peroxide and 100 parts of deionized water, at 20° C. over 1 hour with stirring. Then, the resulting mixture was aged at 25° C. for 2 hours, giving a yellow, transparent, slightly viscous aqueous peroxo titanic acid solution. Further, a solution of 5 parts of polyethylene glycol (molecular weight: 2,000) in 15 parts of deionized water was added and stirred into the aqueous peroxo titanic acid solution, to obtain a coating composition for forming a titanium oxide according to the present invention.

### EXAMPLE 2

A solution of 3 parts of polyethylene glycol (molecular weight: 20,000) in 9 parts of deionized water was added and stirred into the aqueous peroxo titanic acid solution prepared in the same manner as in Example 1, to obtain a coating composition of the invention.

### EXAMPLE 3

An aqueous peroxo titanic acid solution prepared in the same manner as in Example 1 was heated at 95° C. for 6 hours, giving a whitish yellow, translucent titanium oxide dispersion. Into this dispersion was added and stirred a solution of 5 parts of polyethylene glycol (molecular weight: 2,000) in 15 parts of deionized water, to obtain a coating composition of the invention.

### EXAMPLE 4

The coating composition of Example 1 and the coating composition of Example 3 were mixed and stirred at a weight ratio of 1:1, to obtain a coating composition of the invention.

### EXAMPLE 5

Into an aqueous peroxo titanic acid solution prepared in the same manner as in Example 1 were added a solution of 3 parts of polyethylene glycol (molecular weight: 20,000) in 9 parts of deionized water, and 2 parts of a photocatalytic titanium oxide powder “P25” (tradename of Nippon Aerosil Co., Ltd.). The resulting mixture was dispersed for 1 hour using 3 mm alumina beads in a paint shaker, to obtain a coating composition of the invention.

### COMPARATIVE EXAMPLE 1

A mixture of 10 parts of tetraisopropoxytitanium and 10 parts of isopropanol was added dropwise to a mixture of 10 parts of 30% aqueous hydrogen peroxide and 100 parts of deionized water, at 20° C. over 1 hour with stirring. Then, the resulting mixture was aged at 25° C. for 2 hours, giving a yellow, transparent, slightly viscous comparative coating composition for forming a titanium oxide.

### COMPARATIVE EXAMPLE 2

2 parts of a photocatalytic titanium oxide powder “P25” (a tradename of Nippon Aerosil Co., Ltd.) was added to the coating composition of Comparative Example 1. The resulting mixture was dispersed for 1 hour using 3 mm alumina beads in a paint shaker, to obtain a comparative coating composition.

### COMPARATIVE EXAMPLE 3

10% aqueous ammonia was added dropwise to 500 cc of an aqueous solution obtained by diluting 5 cc of a 60% aqueous titanium tetrachloride solution with distilled water, to precipitate titanium hydroxide. The precipitates were washed with distilled water, mixed with 10 cc of a 30% aqueous hydrogen peroxide solution and stirred, giving 70 cc of a yellow, translucent, viscous liquid containing titanium hydroxide (comparative coating composition).

### COMPARATIVE EXAMPLE 4

Titanium hydroxide was dispersed in water to a concentration of 0.2 mol/l, to obtain a comparative coating composition.

### TEST EXAMPLE 1

The coating compositions of Examples 1 to 5 and Comparative Examples 1 to 4 were tested for storage stability by the method described above.

Further, each of the coating compositions was applied to a glass plate to a thickness of 1.0 μm (when calcined) using a bar coater, and calcined at 500° C. for 30 minutes to form a porous anatase titanium oxide film. Using the plates with titanium oxide films thus obtained, the film condition, adhesion, pencil hardness, water resistance, wettability (water contact angle) and specific surface area were tested by the methods described above.

Table 1 shows the test results.

TABLE 1

| | | | | | | Water | Specific |
|---|---|---|---|---|---|---|---|
| | Storage | Film | | Pencil | Water | contact | surface |
| | stability | condition | Adhesion | hardness | resistance | angle | area |
| Ex. 1 | No change | Good | 100 | 3H | Good | Up to 10° | 100 m²/g |
| Ex. 2 | No change | Good | 100 | 3H | Good | Up to 10° | 120 m²/g |
| Ex. 3 | No change | Good | 100 | 3H | Good | Up to 10° | 130 m²/g |
| Ex. 4 | No change | Good | 100 | 3H | Good | Up to 10° | 110 m²/g |
| Ex. 5 | No change | Good | 100 | 3H | Good | Up to 10° | 120 m²/g |
| Comp. | No change | Good | 100 | 3H | Good | At least | 30 m²/g |
| Ex. 1 | | | | | | 30° | |
| Comp. | No change | Good | 100 | 3H | Good | At least | 40 m²/g |
| Ex. 2 | | | | | | 30° | |
| Comp. | Slight | Slight | 100 | 2H | Slight | At least | 30 m²/g |
| Ex. 3 | thickening | clouding | | | blushing | 30° | |
| Comp. | Some | Some | 100 | 3B or | The film | At least | 10 m²/g |
| Ex. 4 | precipitates | cracks | | less | eliminated | 50° | |

### TEST EXAMPLE 2

An acetaldehyde gas decomposition test was carried out as follows: Each of the coating compositions of Example 1, Comparative Example 1 and Comparative Example 4 was applied to a glass plate to a thickness of 1.0 μm (when calcined) using a bar coater, and calcined at 500° C. for 30 minutes to obtain a porous anatase titanium oxide film. A closed laboratory equipped with a 4 KW high pressure mercury lamp was filled with acetaldehyde. The plate obtained above was placed about 30 cm away from the lamp. The amount of acetaldehyde in the laboratory (initial amount: 0.1 g) was measured after 1 hour and 3 hours to find the decrease in the amount of acetaldehyde. Table 2 shows the results.

TABLE 2

| | After 1 hour | After 3 hours |
|---|---|---|
| Ex. 1 | 125 ppm | 250 ppm |
| Comp. | 100 ppm | 200 ppm |
| Ex. 1 | | |
| Comp. | 20 ppm | 35 ppm |
| Ex. 4 | | |

### TEST EXAMPLE 3

A stain resistance test was carried out in the following manner: Each of the coating compositions of Example 2, Comparative Example 1 and Comparative Example 4 was applied to a glass plate to a thickness of 1.0 μm (when calcined) using a bar coater, and calcined at 500° C. for 30 minutes to form a porous anatase titanium oxide film. Then, a 3% methylene blue solution was applied to the film and dried, and the resulting film was irradiated with 1.2 mW/cm² of black light from a distance 10 cm away from the film for 1 hour. The film was checked for staining with the naked eye to evaluate the stain resistance. Table 3 shows the test results.

TABLE 3

| | Staining |
|---|---|
| Ex. 2 | Substantially no staining; |
| | Good stain resistance |
| Comp. Ex. 1 | Slight staining; |
| | Inferior stain resistance |
| Comp. Ex. 4 | The same degree of staining |
| | as the staining before |
| | irradiation; |
| | Poor stain resistance |

### TEST EXAMPLE 4

An energy converting property test was carried out in the following manner: Each of the coating compositions of Example 5, Comparative Example 2 and Comparative Example 4 was applied to a fluorine-doped tin oxide conductive glass to a thickness of 8 μm (when calcined) using an applicator, and calcined at 500° C. for 30 minutes to obtain a porous anatase titanium oxide film. The titanium oxide film was soaked in a 0.1% ethanol solution of a ruthenium complex represented by Ru(II)(bipyridine dicarboxylic acid)2(isothiocyanic acid)2, at 20° C. for 24 hours to adsorb the sensitizing dye, giving a sensitized titanium oxide film electrode. The electrode was superimposed on a transparent conductive glass counter electrode. An electrolyte containing iodine/iodine ion redox couple was placed between the electrodes, and the side faces of the resulting structure were sealed with resin. Subsequently, a lead is attached to obtain a photoelectric conversion element. The short circuit current of the photoelectric conversion element was measured using an artificial sun lamp (100 W) manufactured by Solacs at an irradiation intensity of 100 mW/cm². Table 4 shows the test results.

TABLE 4

| | Short circuit |
|---|---|
| | current (mA/cm²) |
| Ex. 5 | 10 |
| Comp. Ex. 2 | 3 |
| Comp. Ex. 4 | 2 |

### TEST EXAMPLE 5

An energy converting property test was carried out in the following manner: Each of porous titanium oxide films prepared in the same manner as in Test Example 4 was soaked in a 1% ethanol solution of Eosin Y at 20° C. for 24 hours to adsorb the sensitizing dye, giving a sensitized titanium oxide film electrode. The short circuit current of this electrode was measured in the same method as in Test Example 4. Table 5 shows the test results.

TABLE 5

| | Short circuit |
|---|---|
| | current (mA/cm²) |
| Ex. 5 | 4 |
| Comp. Ex. 2 | 3 |
| Comp. Ex. 4 | 0.5 |

Examples of Coating Compositions Comprising an Aqueous Peroxo Titanic Acid Solution (A) Obtained by Mixing a Hydrolyzable Titanium Compound With Aqueous Hydrogen Peroxide in the Presence of a Titanium Oxide Sol, and Polyethylene Glycol (B)

### EXAMPLE 6

A mixture of 10 parts of tetraisopropoxytitanium and 10 parts of isopropanol was added dropwise to a mixture of 5 parts (as solids) of “TKS-201” (a titanium oxide sol manufactured by TEICA Corp.), 10 parts of 30% aqueous hydrogen peroxide and 100 parts of deionized water at 10° C. over 1 hour with stirring. The resulting mixture was aged at 10° C. for 24 hours, giving a yellow, transparent, slightly viscous aqueous peroxo titanic acid solution. Further, a solution of 5 parts of polyethylene glycol (molecular weight: 2,000) in 15 parts of deionized water was added and stirred, to obtain a coating composition of the invention.

### EXAMPLE 7

Into an aqueous peroxo titanic acid solution prepared in the same manner as in Example 6 was added and stirred a solution of 3 parts of polyethylene glycol (molecular weight: 20,000) in 9 parts of deionized water, giving a coating composition of the invention.

### EXAMPLE 8

Into an aqueous peroxo titanic acid solution prepared in the same manner as in Example 6 were added a solution of 3 parts of polyethylene glycol (molecular weight: 20,000) in 9 parts of deionized water, and 2 parts of a photocatalytic titanium oxide powder “P25” (a tradename of Nippon Aerosil Co., Ltd.). The resulting mixture was dispersed for 1 hour using 3 mm alumina beads in a paint shaker, to obtain a coating composition of the invention.

### TEST EXAMPLE 6

The coating compositions of Examples 6 to 8 were tested for storage stability by the method described above.

Further, each of the coating compositions was applied to a glass plate to a thickness of 1.0 μm (when calcined) using a bar coater, and calcined at 500° C. for 30 minutes to form a porous anatase titanium oxide film. Using the plates with titanium oxide films thus obtained, the film condition, adhesion, pencil hardness, water resistance, wettability (water contact angle) and specific surface area were tested by the methods described above.

TABLE 6
shows the test results.
Table 6

| | Storage | Film | Ad- | Pencil | Water | water | Specific |
|---|---|---|---|---|---|---|---|
| | stabil- | condi- | he- | hard- | resis- | contact | surface |
| | ity | tion | sion | ness | tance | angle | area |
| Ex. 6 | No | Good | 100 | 3H | Good | Up to | 120 m²/g |
| | change | | | | | 10° | |
| Ex. 7 | No | Good | 100 | 3H | Good | Up to | 130 m²/g |
| | change | | | | | 10° | |
| Ex. 8 | No | Good | 100 | 3H | Good | Up to | 140 m²/g |
| | change | | | | | 10° | |

### TEST EXAMPLE 7

An acetaldehyde gas decomposition test was carried out as follows: The coating composition of Example 6 was applied to a glass plate to a thickness of 1.0 μm (when calcined) using a bar coater, and calcined at 500° C. for 30 minutes to obtain a porous anatase titanium oxide film. A closed laboratory equipped with a 4 KW high pressure mercury lamp was filled with acetaldehyde. The plate obtained above was placed about 30 cm away from the lamp. The amount of acetaldehyde in the laboratory (initial amount: 0.1 g) was measured after 1 hour and 3 hours to find the decrease in the amount of acetaldehyde. Table 7 shows the results.

TABLE 7

| | After 1 hour | After 3 hours |
|---|---|---|
| Ex. 6 | 130 ppm | 260 ppm |

### TEST EXAMPLE 8

A stain resistance test was carried out in the following manner: The coating composition of Example 6 was applied to a glass plate to a thickness of 1.0 μm (when calcined) using a bar coater, and calcined at 500° C. for 30 minutes to form a porous anatase titanium oxide film. Then, a 3% methylene blue solution was applied to the obtained plate and dried, and the plate was irradiated with 1.2 mW/cm² of black light from a distance 10 cm away from the plate for 1 hour. The film was checked for staining with the naked eye to evaluate the stain resistance. Table 8 shows the results.

TABLE 8

| | Staining |
|---|---|
| Ex. 6 | Substantially no staining; |
| | Good stain resistance |

### TEST EXAMPLE 9

An energy converting property test was carried out in the following manner: The coating composition of Example 8 was applied to a fluorine-doped tin oxide conductive glass to a thickness of 8 μm (when calcined) using an applicator, and calcined at 500° C. for 30 minute to obtain a porous anatase titanium oxide film. The titanium oxide film was soaked in a 0.1% ethanol solution of a ruthenium complex represented by Ru (II)(bipyridine dicarboxylic acid)2(isothiocyanic acid)2, at 20° C. for 24 hours to adsorb the sensitizing dye, giving a sensitized titanium oxide film electrode. The electrode was superimposed on a transparent conductive glass counter electrode. An electrolyte containing iodine/iodine ion redox couple was placed between the electrodes, and the side faces of the resulting structure were sealed with resin. Subsequently, a lead is attached to obtain a photoelectric conversion element. The short circuit current of the photoelectric conversion element was measured using an artificial sun lamp (500 W) manufactured by Solacs at an irradiation intensity of 100 mW/cm². Table 4 shows the test results.

TABLE 9

| | Short circuit |
|---|---|
| | current (mA/cm²) |
| Ex. 8 | 11 |

### TEST EXAMPLE 10

An energy converting property test was carried out in the following manner: The porous titanium oxide film of Test Example 9 was soaked in a 1% ethanol solution of Eosin Y at 20° C. for 24 hours to adsorb the sensitizing dye, giving a sensitized titanium oxide film electrode. The measurement of short circuit was carried out in the same manner as in Test Example 9. Table 10 shows the test results.

TABLE 10

| | Short circuit |
|---|---|
| | current (mA/cm²) |
| Ex. 8 | 4.5 |

The coating composition for forming a titanium oxide film, process for forming a titanium oxide film and a photocatalyst according to the present invention has the following remarkable advantages:

(1) The coating composition contains only a slight amount of impurities (substances other than titanium oxide) and thus is capable of forming a high purity titanium oxide film.

(2) The coating composition has excellent storage stability.

(3) The coating composition can be produced in a simple manner that does not require by-product treatment or like treatment during production.

(4) The process for forming a titanium oxide film using the coating composition is capable of easily producing a uniform, dense, porous titanium oxide film having good adhesion to substrates. Further, the process is capable of forming a thick film (1 μm or thicker) with ease.

(5) The obtained porous film is usually made of anatase titanium oxide and has greatly improved photocatalytic activities.

(6) When the coating composition is prepared by using an aqueous peroxo titanic acid solution (A) obtained by mixing a hydrolyzable titanium compound with aqueous hydrogen peroxide in the presence of a titanium oxide sol, the coating composition has more improved storage stability, and the thick film can be formed more easily.

(7) The photocatalyst comprising a porous titanium oxide film formed on a substrate by the process is remarkably improved in photocatalytic activities of titanium oxide. Therefore, the photocatalyst is suitably usable in the fields of, for example, atmosphere purification treatments such as toxic gas decomposition, and energy conversion.

1. A coating composition for forming a titanium oxide film, comprising (A) an aqueous peroxo titanic acid solution obtained by mixing, with aqueous hydrogen peroxide, a titanium compound containing a group or groups convertible into a hydroxyl group by hydrolysis and/or a low condensate of the compound and (B) polyethylene glycol.

2. A coating composition according to claim 1, wherein the titanium compound is a tetraalkoxytitanium represented by the formula
Ti(OR)₄ (I)
wherein Rs may be the same or different and each represent C₁ to C₅ alkyl.

3. A coating composition according to claim 1, wherein the low condensate of a titanium compound is a compound having a condensation degree of 2 to 30 and obtained by self-condensing a tetraalkoxytitanium represented by the formula
Ti(OR)₄ (I)
wherein Rs may be the same or different and each represent C₁ to C₅ alkyl.

4. A coating composition according to claim 1, wherein the proportion of the aqueous hydrogen peroxide is 0.1 to 100 parts by weight calculated as hydrogen peroxide, per 10 parts by weight of the titanium compound containing a group or groups convertible into a hydroxyl group by hydrolysis and/or a low condensate of the compound.

5. A coating composition according to claim 1, wherein the aqueous peroxo titanic acid solution (A) is a solution obtained by mixing a titanium compound containing a group or groups convertible into a hydroxyl group by hydrolysis and/or a low condensate of the compound, with aqueous hydrogen peroxide in the presence of a titanium oxide sol.

6. A coating composition according to claim 5, wherein the titanium oxide sol is an aqueous dispersion of anatase titanium oxide.

7. A coating composition according to claim 5, wherein the proportion of the titanium oxide sol is 0.01 to 10 parts by weight as solids, per 1 part by weight of the titanium compound containing a group or groups convertible into a hydroxyl group by hydrolysis and/or a low condensate of the compound.

8. A coating composition according to claim 1, wherein the aqueous peroxo titanic acid solution (A) is a dispersion of titanium oxide particles having an average particle size not greater than 10 nm, the dispersion being obtainable by: mixing, with aqueous hydrogen peroxide, a titanium compound containing a group or groups convertible to a hydroxyl group by hydrolysis and/or a low condensate of the compound; and subjecting the resulting aqueous peroxo titanic acid solution to heat treatment or autoclave treatment at a temperature not lower than 80° C.

9. A coating composition according to claim 1, wherein the polyethylene glycol (B) has an average molecular weight of 200 to 4,000,000.

10. A coating composition according to claim 1, wherein the proportion of the polyethylene glycol (B) is 0.1 to 200 parts by weight, per 100 parts by weight of the solids in the aqueous peroxo titanic acid solution (A).

11. A process for forming a titanium oxide film, comprising the steps of applying a coating composition according to claim 1 to a substrate, and calcining the resulting coating at a temperature not lower than 200° C. to form a porous titanium oxide film.

12. A process for forming a titanium oxide film according to claim 11, wherein the porous titanium oxide film is a porous film of anatase titanium oxide.

13. A photocatalyst comprising a porous titanium oxide film formed on a substrate by a process according to claim 11.

14. A photocatalyst according to claim 13, wherein the porous titanium oxide film is a porous film of anatase titanium oxide.
